(19) United States
(12) Patent Application Publication
(10) Pub. No.: US 2013/0095370 A1
(43) Pub. Date: Apr. 18, 2013

(54) BATTERY ASSEMBLY PRODUCTION METHOD AND BATTERY ASSEMBLY

(71) Applicants: Shinji Ota, Osaka (JP); Shinsuke Fukuda, Osaka (JP)

(72) Inventors: Shinji Ota, Osaka (JP); Shinsuke Fukuda, Osaka (JP)

(73) Assignee: PANASONIC CORPORATION, Osaka (JP)

(21) Appl. No.: 13/704,557

(22) PCT Filed: Jun. 1, 2011
(86) PCT No.: PCT/JP2011/003074

§ 371 Date: Dec. 14, 2012

(30) Foreign Application Priority Data
Jun. 14, 2010 (JP) 2010-135034

(51) Int. Cl. H01M 2/22; B23K 26/20

(52) U.S. Cl. CPC H01M 2/22; B23K 26/20
USPC 429/158; 29/623.1; 219/121.64

(57) ABSTRACT

A battery assembly production method is provided that enables the reduction in mechanical stress caused in at least one cell. A battery assembly produced by this method is also provided. The method includes a first welding step of resistance-welding a connection member 5A to a cell 4b, and a second welding step of welding the connection member 5A to a cell 4a subsequent to the first welding step. In at least the second welding step out of the first and second welding steps, an end surface of the connection member 5A, which rises from an outer side surface of the cell 4a when the connection member 5A is brought into contact with the outer side surface, is melted and welded to the cell 4a without pressing the connection member 5A.

### TECHNICAL FIELD

The present invention is a technology concerning a battery assembly that has a plurality of serially disposed cells.

### BACKGROUND ART

There has conventionally been known a battery assembly that has a plurality of serially disposed electric cells (cells) and a coupling plate provided between the electric cells adjacent to each other (e.g., Patent Document 1). The battery assembly of Patent Document 1 is produced by welding one end part of the coupling plate to the positive electrode of either one of the electric cells (cells), welding the other end part of the coupling plate to the negative electrode of the other electric cell, and folding the coupling plate in half to dispose the electric cells in series.

Specifically, when producing the battery assembly of Patent Document 1, a current is applied to the coupling plate having a welding bead formed on the back surface thereof, while the coupling plate is pressed from the front side of the coupling plate against end surfaces of the electric cells. As a result, the bead melts and the coupling plate can be welded to the electric cells.

However, in the production of the battery assembly of Patent Document 1, the coupling plate needs to be pressed against the electric cells at the time of resistance-welding, in order to melt the back surface (bead) of the coupling plate and weld the coupling plate to the electric cells. For this reason, mechanical stress is caused in each of the electric cells due to the pressing force.

Patent Document 1: Japanese Patent Application Publication No. 2005-11629

### SUMMARY OF THE INVENTION

An object of the present invention is to provide a battery assembly production method that is capable of reducing mechanical stress caused in at least one cell, and a battery assembly produced by this production method.

In order to achieve this object, the present invention provides a battery assembly production method for producing a battery assembly a having a first cell and second cell disposed serially such that a positive electrode and a negative electrode of the respective cells face each other, and a connection member provided between the first cell and the second cell and electrically connecting the positive electrode and the negative electrode of the cells that face each other, the method including a first welding step of welding the connection member to the first cell, and a second welding step of welding the connection member to the second cell subsequent to the first welding step, wherein in at least the second welding step out of the first and second welding steps, an end surface of the connection member, which rises from an outer side surface of the second cell when the connection member is brought into contact with the outer side surface, is melted and welded to the second cell without pressing the connection member.

The present invention also provides a battery assembly having first and second cells disposed serially and a connection member provided between the first cell and the second cell and electrically connecting a positive electrode and a negative electrode of the respective cells that face each other, wherein a first welding part in which the first cell and the connection member are welded to each other and a second welding part in which the second cell and the connection member are welded to each other are provided in a region between the first cell and the second cell, and at least the second welding part out of the first and second welding parts is a laser welding part that faces an end surface of the connection member, which rises from a front surface of the second cell.

The present invention can reduce mechanical stress caused in a cell.

### BRIEF DESCRIPTION OF THE DRAWINGS

FIG. 1 is an exploded perspective view showing the entire configuration of a battery pack according to an embodiment of the present invention.

FIG. 2 is a perspective view showing an enlargement of a connection member shown in FIG. 1.

FIG. 3 is a side view of the connection member shown in FIG. 2.

FIG. 4 is a partial cross-sectional side view diagram showing how a cell is resistance-welded to the connection member.

FIG. 5 is a partial cross-sectional side view diagram showing how a cell is laser-welded to the connection member shown in FIG. 4.

FIG. 6 is a perspective view showing a modification of the connection member.

FIG. 7 is a partial cross-sectional side view diagram showing a method for producing a battery assembly according to another embodiment of the present invention, the diagram showing a state of resistance-welding a cell to a connection member.

FIG. 8 is a partial cross-sectional side view diagram showing how the cell is laser-welded to the connection member shown in FIG. 7.

### BEST MODE FOR CARRYING OUT THE INVENTION

Embodiments of the present invention are described hereinafter with reference to the accompanying drawings. Note that the following embodiments are merely examples embodying the present invention and do not limit the technical scope of the present invention.

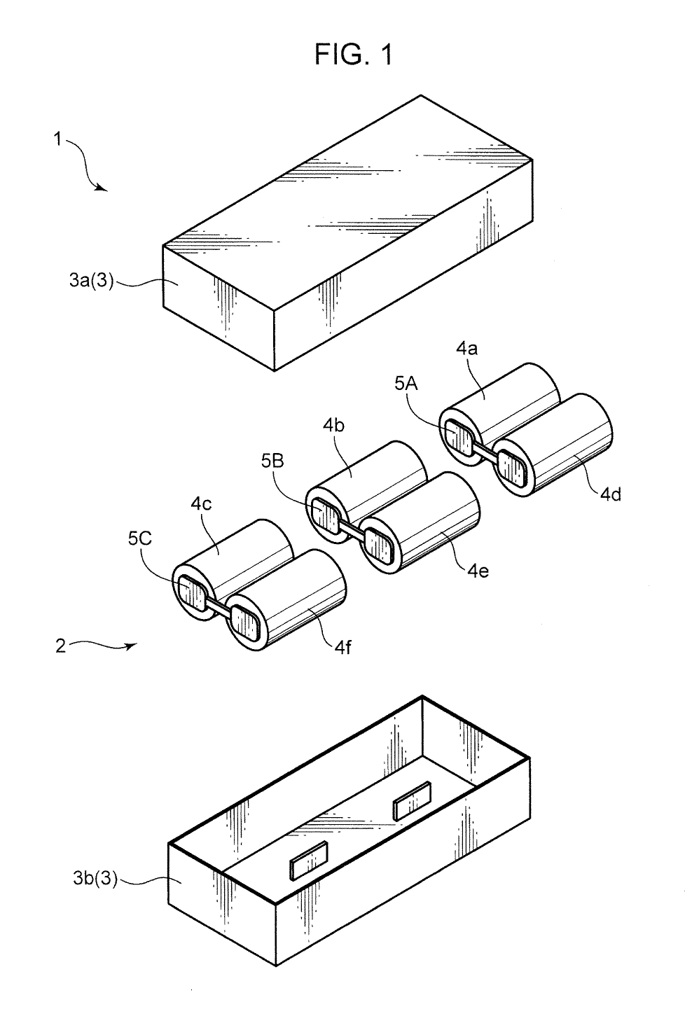

FIG. 1 is an exploded perspective view showing the entire configuration of a battery pack according to an embodiment of the present invention.

As shown in FIG. 1, a battery pack 1 has a battery assembly 2 and a covering member 3 for covering the battery assembly 2. The covering member 3 has a bottomed container 3b for storing the battery assembly 2 and a lid body 3a covering an opening part of the bottomed container 3b and surrounding side walls of the bottomed container 3b. A safety device that is connected electrically to the battery assembly 2 is stored in the covering member 3 as well.

The battery assembly 2 has six cells 4a to 4f and connection member 5A to 5C for electrically connecting these cells 4a to 4f. In the present embodiment, the cells 4a to 4c are disposed in series, and the cells 4d to 4f are disposed in series. These two rows of serially disposed cells are disposed in parallel. The connection member 5A electrically connects a negative electrode of the cell 4a to a positive electrode of the cell 4b, electrically connects a negative electrode of the cell 4d to a positive electrode of the cell 4e, and electrically connects the negative electrodes of the cells 4a and 4d to each other. The connection member 5B electrically connects a negative electrode of the cell 4b to a positive electrode of the cell 4c, electrically connects a negative electrode of the cell 4e to a positive electrode of the cell 4f, and electrically connects the negative electrodes of the cells 4b and 4e to each other. The connection member 5C electrically connects a negative electrode of the 4c to the negative electrode of the 4f. An end surface of the battery assembly 2 on the other side of the connection member 5C is provided with a connection member (not shown) for electrically connecting a positive electrode of the cell 4a to a positive electrode of the cell 4d. A specific configuration of the battery assembly 2 is described hereinafter.

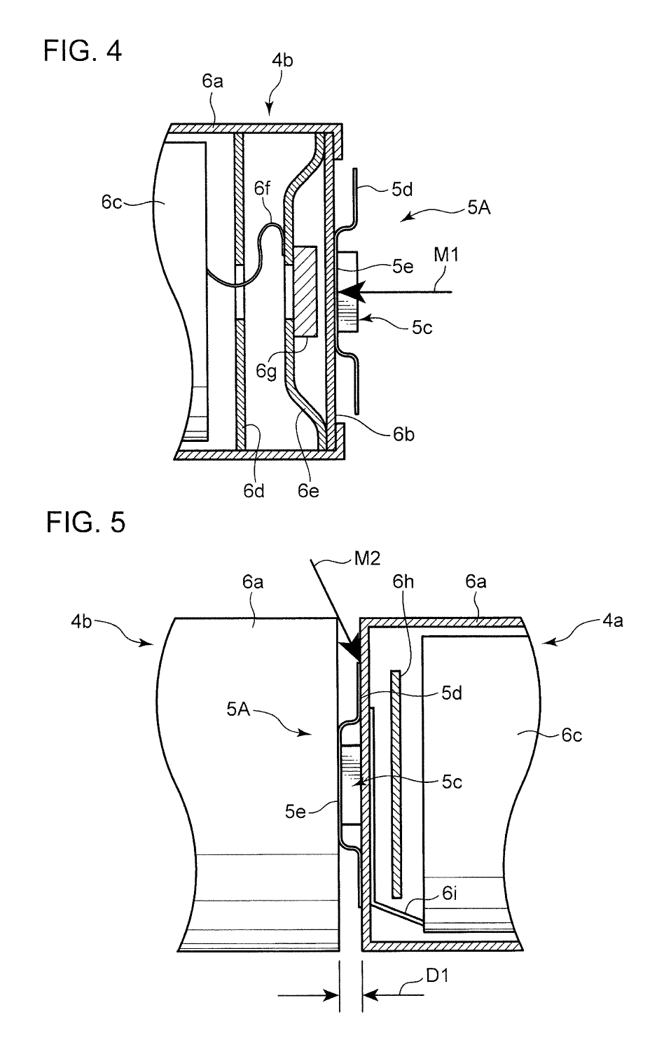

The cells 4a to 4f are lithium-ion secondary batteries of the same configuration. FIG. 4 is a cross-sectional diagram showing the positive electrode of the cell 4a. FIG. 5 is a cross-sectional diagram showing the negative electrode of the cell 4b. Examples of the configurations of the cells 4a and 4b are now described with reference to these diagrams.

Each of the cells 4a, 4b has a cylindrical bottomed case 6a, a bottom plate 6b provided at an open end of the bottomed case 6a, and an electrode group 6c, insulating plates 6d, 6h, a sealing plate 6e, and an exhaust valve 6g that are provided in a chamber between the bottomed case 6a and the bottom plate 6b. The electrode group 6c is configured by rolling up a positive electrode sheet, negative electrode sheet, and separator. An outermost circumferential surface of the electrode group 6c is configured by the separator. A positive electrode lead 6f is connected to the electrode group 6c. The positive electrode lead 6f is electrically connected to the sealing plate 6e. Due to the electrical connection between the sealing plate 6e and the bottom plate 6b, the bottom plate 6b functions as an end surface of each cell 4a, 4b that configures the positive electrode. On the other hand, a negative electrode lead 6i is connected to the electrode group 6c. The negative electrode lead 6i is electrically connected to a bottom surface of the bottomed case 6a. Thus, the bottom surface of the bottomed case 6a functions as an end surface of each cell 4a, 4b that configures the negative electrode. The insulating plate 6d is provided between the electrode group 6c and the bottom plate 6b in order to insulate the electrode group 6c and the bottom plate 6b from each other. Similarly, the insulating plate 6h is provided between the electrode group 6c and the bottom surface of the bottomed case 6a in order to insulate the electrode group 6c and the bottomed case 6a from each other. The sealing plate 6e is provided between the insulating plate 6d and the bottom plate 6b so as to close the opening of the bottomed case 6a. The exhaust valve 6g is provided between the sealing plate 6e and the bottom plate 6b and is fixed to the sealing plate 6e so as to close a hole formed in the sealing plate 6e. This exhaust valve 6g is opened in order to guide gas generated in the bottomed case 6a to the outside of the bottomed case 6a when the pressure of the gas becomes equal to or greater than a predetermined level.

In these cells 4a to 4f, the distance between the positive-electrode-side end surface (the bottom plate 6b) or the negative-electrode-side end surface (the bottom surface of the bottomed case 6a) and the electrode group 6c is greater than the distance between the side surface of the bottomed case 6a and the electrode group 6c. Specifically, a space for disposing the positive electrode lead 6f, the insulating plate 6d, the sealing plate 6e, and the exhaust valve 6g therein needs to be provided between the bottom plate 6b and the electrode group 6c. Also, a space for disposing the negative electrode lead 6i and the insulating plate 6h therein needs to be provided between the bottom surface of the bottomed case 6a and the electrode group 6c. However, such space is not required between the side surface of the bottomed case 6a and the electrode group 6c. Especially in recent years, the distance between the side surface of the bottomed case 6a and the electrode group 6c is designed to be small in order to respond to a request for a reduction in size of the cells 4a to 4f. For this reason, the difference between the distance between the side surface of the bottomed case 6a and the electrode group 6c and the distance between the positive-electrode-side end surface or the negative-electrode-side end surface and the electrode group 6c tends to increase.

The distance between the positive-electrode-side end surface (the bottom plate 6b) and the electrode group 6c is greater than the distance between the negative-electrode-side end surface (the bottom surface of the bottomed case 6a) and the electrode group 6c. Specifically, in addition to configurations corresponding to the negative electrode lead 6i and the insulating plate 6h provided between the negative-electrode-side end surface and the electrode group 6c, a space for disposing the sealing plate 6e and the exhaust valve 6g therein needs to be provided between the positive-electrode-side end surface and the electrode group 6c. Therefore, the distance between the positive-electrode-side end surface and the electrode group 6c becomes greater than the distance between the negative-electrode-side end surface and the electrode group 6c.

In consideration of the structural characteristics of the cells 4a to 4f described above, in the present embodiment, the connection member 5A or connection member 5B is resistance-welded to the positive-electrode-side end surface (the bottom plate 6b) of each cell 4b, 4c, 4e, 4f. Also, the connection member 5A or connection member 5B is laser-welded to the negative-electrode-side end surface (the bottom surface of the bottomed case 6a) of each cell 4a, 4b, 4d, 4e.

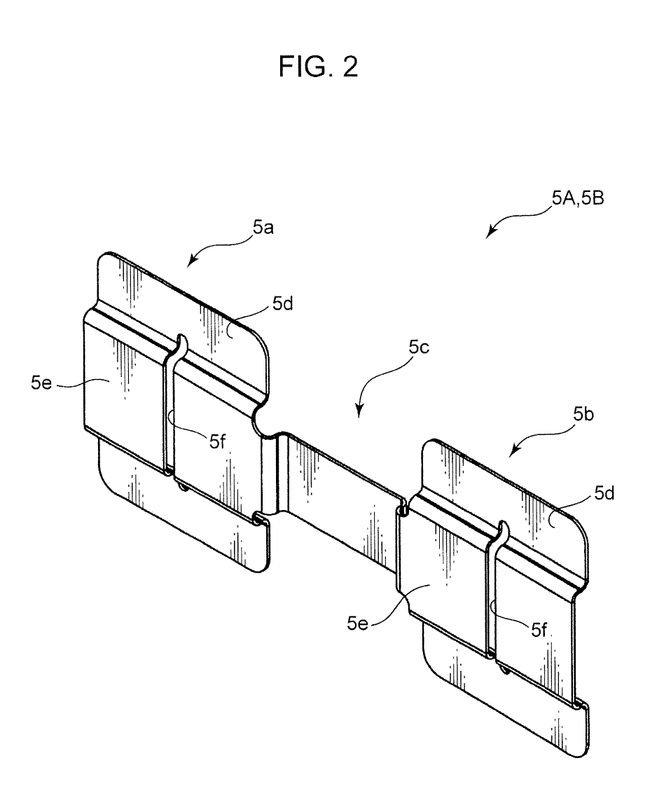

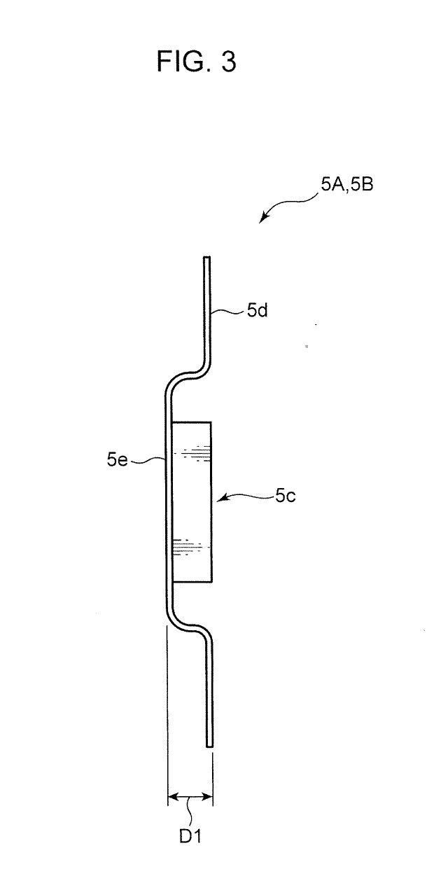

FIG. 2 is a perspective view showing an enlargement of the connection member 5A, 5B shown in FIG. 1. FIG. 3 is a side view of the connection member 5A, 5B shown in FIG. 2. The connection members 5A and 5B are of the same configuration; thus, an example of the configuration of the connection member 5A is described hereinafter.

As shown in FIGS. 2 and 3, the connection member 5A is formed by bending a metal plate at proper sections. The connection member 5A has a first connection part 5a for electrically connecting the negative electrode of the cell 4a and the positive electrode of the cell 4b that face each other, a second connection part 5b for electrically connecting the negative electrode of the cell 4d and the positive electrode of the cell 4e that face each other, and a coupling part 5c for coupling the first connection part 5a and the second connection part 5b to each other. Note that the first connection part 5a and the second connection part 5b are of the same configuration except that they are symmetric; thus, only the configuration of the first connection part 5a is described hereinafter.

The first connection part 5a is provided between the negative-electrode-side end surface (the bottom surface of the bottomed case 6a) of the cell 4a and the positive-electrode-side end surface (the bottom plate 6b) of the cell 4b, and is welded to the both end surfaces. The welded section between the first connection part 5a and the cell 4a (the section indicated by the arrow M2 in FIG. 5) and the welded section between the first connection part 5a and the cell 4b (the section indicated by the arrow M1 in FIG. 4) are provided in a region between the cell 4a and the cell 4b. More specifically, the first connection part 5a is formed into a size such that, when being projected along a longitudinal direction (axis line direction) of each cell 4a, 4b, the first connection part 5a can be disposed in the range of the projected shape of the end surface of each cell 4a, 4b.

The first connection part 5a is a metal plate that integrally has a pair of base parts 5d and a protruding part 5e protruding from each base part 5d to the front side between these base parts 5d. In the present embodiment, while the protruding part 5e is welded to the cell 4b, the base parts 5d are welded to the cell 4a. A distance D1 (see FIG. 3) between a front surface of the protruding part 5e and a back surface of each base part 5d is set at a distance (e.g., 1 mm) required for performing laser-welding described hereinafter. A slit 5f that penetrates through the first connection part 5a across the base part 5d and its protruding part 5e is formed in the first connection part 5a. The slit 5f is provided in order to effectively melt the connection member 5A by lengthening a path of current applied at the time of resistance-welding described hereinafter.

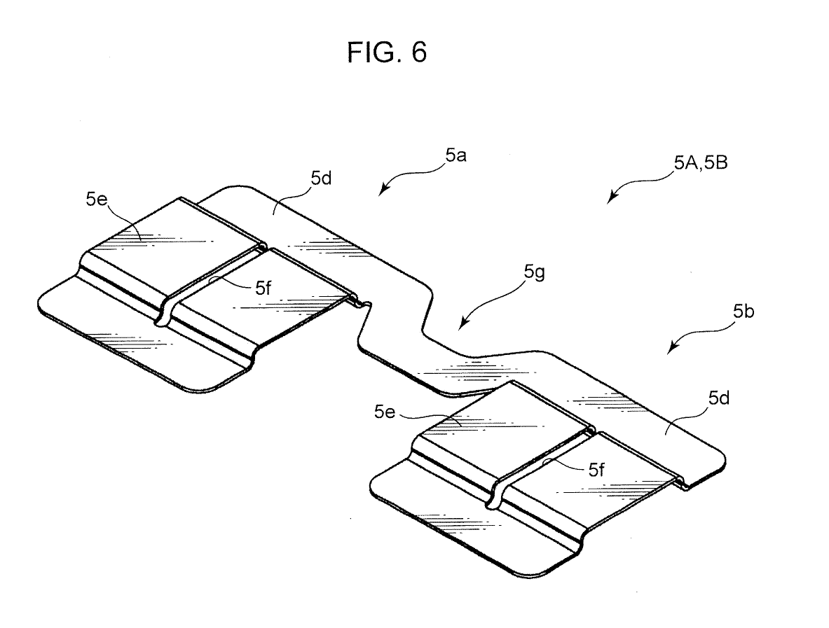

The coupling part 5c couples the protruding part 5e of the first connection part 5a and the protruding part 5e of the second connection part 5b to each other. As shown in FIG. 3, the coupling part 5c is folded back from each protruding part 5e to the back side such that a back surface of the coupling part 5c and a back surface of each base part 5d are positioned in the same plane. The present embodiment has described the coupling part 5c that couples the protruding parts 5e to each other; however, a coupling part 5g for coupling the base parts 5d to each other can be adopted as shown in FIG. 6.

A method for producing the battery pack 1 is described hereinafter with reference to FIGS. 2, 4 and 5. FIG. 4 is a partial cross-sectional side view diagram showing how the cell 4b is resistance-welded to the connection member 5A. FIG. 5 is a partial cross-sectional side view diagram showing how the cell 4a is laser-welded to the connection member 5A shown in FIG. 4.

First, as shown in FIG. 2, the connection member 5A is prepared in a manner that the distance D1 between the front surface of the protruding part 5e and the back surface of each base part 5d is set at a predetermined distance (e.g., 1 mm) required for performing laser-welding (separation step). By preparing this connection member 5A, a space corresponding to the distance D1 that is required for laser-welding can be secured between the cell 4a and the cell 4b in the following step.

Next, as shown in FIG. 4, the front surface of the protruding part 5e of the first connection part 5a is brought into contact with the positive-electrode-side end surface (the bottom plate 6b) of the cell 4b, and a pair of electrodes (not shown) for resistance-welding is brought into abutment against the back surface of this protruding part 5e. In so doing, the electrodes for resistance-welding are positioned so as to be brought into abutment against the back surface on both sides of the protruding part 5e having the slit 5f therebetween. Subsequently, while pressing each electrode against the cell 4b, a current is passed between the electrodes, as indicated by the arrow M1. Consequently, the front surface of the first connection part 5a (the protruding part 5e) is melted to resistance-weld the first connection part 5a to the cell 4b (the bottom plate 6b) (the first welding step).

In the present embodiment, the end surface of the cell 4b (the bottom plate 6b) that is relatively far from the electrode group 6c is subjected to the resistance-welding. For this reason, mechanical stress that is incurred to the electrode group 6c due to the pressure of the resistance-welding can be reduced more than when resistance-welding the first connection part 5a to the side surface of the bottomed case 6a that is relatively close to the electrode group 6c. In the present embodiment, the resistance-welding is performed on the positive-electrode-side end surface that is farther from the electrode group 6c than the negative-electrode-side end surface is. Therefore, compared to when performing the resistance-welding on the negative-electrode-side end surface, mechanical stress that is incurred to the electrode group 6c due to the pressing force of the resistance-welding can be reduced.

As shown in FIG. 5, the cell 4a is disposed such that the negative-electrode-side end surface of the cell 4a (the bottom surface of the bottomed case 6a) comes into contact with the back-side surface of each base end part 5d of the first connection part 5a that is welded to the bottom plate 6b in the first welding step (disposing step). This disposing step can automatically form a gap between the cell 4a and the cell 4b, the gap corresponding to the distance D1 between the front surface of the protruding part 5e and the back surface of each base part 5d.

Next, laser-welding is performed on the end surface of the base part 5d that rises from the negative-electrode-side end surface of the cell 4a (the second welding step). Specifically, in the second welding step a laser is radiated to the end surface of the base part 5d through the gap between the cell 4a and the cell 4b, as indicated by the arrow M2. In the present embodiment, a laser radiation range is configured by a part of one of the long sides of the base part 5d (the upper side of the upper base part 5d shown in FIG. 2), the output of the laser 50 W to 300 W, and a laser radiation time 0.01 sec to 0.5 sec. The angle of the optical axis of the laser with respect to the end surface of the cell 4a is 5° to 30°. Radiation of the laser under these conditions can melt the end surface of the base part 5d and harden the end surface again, thereby welding the first connection part 5a to the cell 4a. Note that, in the second welding step of the present embodiment, only a part of one of the long sides of the base part 5d is laser-welded, but the entire long side of the base part 5d may be laser-welded. In addition, the short sides of the base part 5d (the left and right sides shown in FIG. 2) or the other base part 5d (the lower base part 5d shown in FIG. 2) can also be laser-welded.

Each of the steps described above is carried out parallel to the work of connecting the cell 4d and the cell 4e to each other. The battery assembly 2 is produced by similarly performing the work for connecting the cell 4b and the cell 4c to each other and the cell 4e and the cell 4f to each other. Subsequently, the battery pack 1 is completed by electrically connecting the battery assembly 2 to the safety device or the like that is not shown and then storing thus obtained product in the covering member 3, as shown in FIG. 1.

As described above, the production method according to the embodiment can melt the end surface of the connection member 5A and weld the connection member 5A to the cell 4a without pressing the connection member 5A. As a result, mechanical stress that is caused in the cell 4a can be reduced.

According to the production method of the present embodiment, after welding the cell 4b and the connection member 5A to each other, the cell 4a can be welded to the connection member 5A disposed between the cell 4b and the cell 4a. Thus, the steps required to produce the battery assembly can be made simpler than those of the conventional production method. In other words, the conventional production method requires a step of disposing both end parts of a coupling plate on two, laterally arranged electric cells and then folding the coupling plate in half after welding the end parts of the coupling plate to the electric cells, to dispose both of the electric cells in a vertical line. The production method according to the embodiment, on the other hand, can weld the connection member 5A to the cell 4a in a state in which the cell 4a is disposed in a vertical direction with respect to the cell 4b after the cell 4b and the connection member 5A are welded to each other. Therefore, the step of folding the coupling plate in half in the conventional production method can be omitted.

According to the production method of the embodiment, in a step prior to the step of connecting the cell 4a, which is a step prior to a step of restricting a space on an end surface of the cell 4b (a first end surface) by means of the cell 4a, this space is used to let an electrode fall to the connection member 5A disposed on the end surface of the cell 4b, to effectively perform the resistance-welding. Then, in the second welding step, a laser is radiated from between the end surface of the cell 4a and the end surface of the cell 4b (sides of the cells 4a, 4b) to the end surface of the base part 5d disposed in the limited space between the end surface of the cell 4b and the end surface of the cell 4a (a second end surface). As a result, the connection member 5A can reliably be welded to the end surface of the cell 4a.

In the production method according to the present embodiment, the connection member 5A is prepared in a manner that the distance D1 between the back surface of each base part 5d and the front surface of the protruding part 5e is set at a distance required for performing laser-welding. By disposing the connection member 5A between the cells 4a and 4b, a space in which a laser can be radiated to the end surface of the base part 5d can be formed between the end surface of the cell 4b and the end surface of the cell 4a.

According to battery assembly 2 of the embodiment, a resistance-welding part and laser welding part are provided within the region between the cell 4a and the cell 4b. Accordingly, the battery assembly can be made smaller than the one obtained when each welding part is formed outside the region between the cell 4a and the cell 4b.

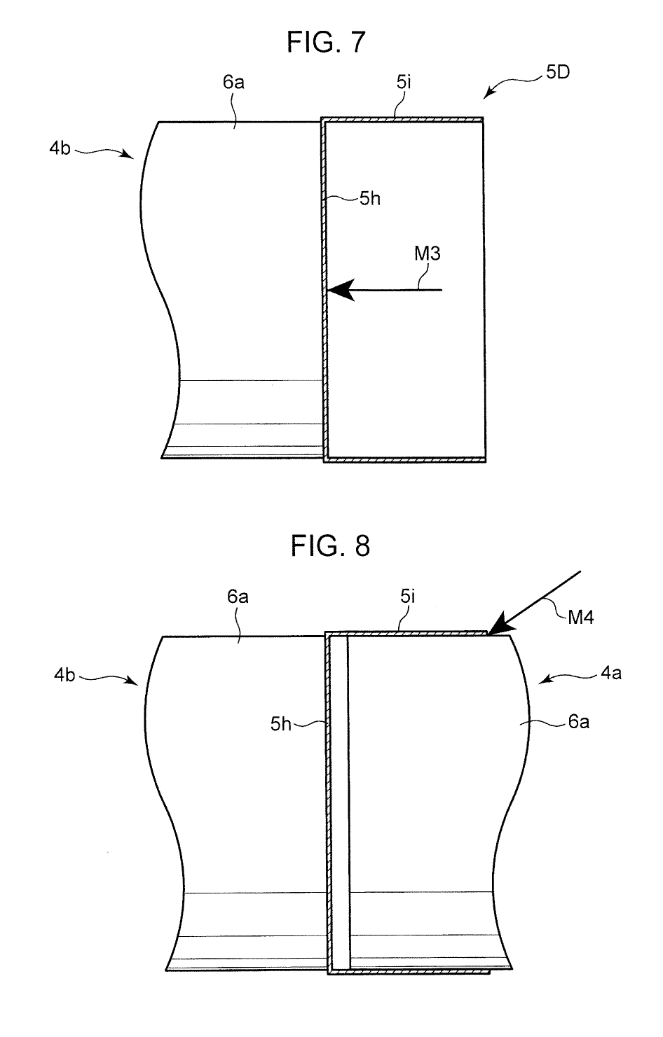

Note that the embodiment has described the configuration in which each welding part between the connection member 5A and each cell 4a, 4b is disposed in the region between the cells 4a and 4b. However, the laser welding part may be disposed outside the region between the cells 4a and 4b. FIG. 7 is a partial cross-sectional side view diagram showing a method for producing a battery assembly according to another embodiment of the present invention, illustrating a state where a connection member 5D is resistance-welded to the cell 4b. FIG. 8 is a partial cross-sectional side view diagram showing how the cell 4a is laser-welded to a connection member 5D shown in FIG. 7.

The connection member 5D according to the present embodiment is a metal member in the shape of a bottomed container having a disk-shaped bottom part 5h and a side wall part 5i that is provided in a standing manner on the entire circumference of a rim part of the bottom part 5h. A method for using the connection member 5D to connect the cell 4a and the cell 4b to each other is now described hereinafter.

As shown in FIG. 7, first, a front surface of the bottom part 5h of the connection member 5D is brought into contact with the positive-electrode-side end surface of the cell 4b, and a pair of electrodes (not shown) for resistance-welding is brought into abutment against a back surface of the bottom part 5h. Next, while pressing each electrode against the cell 4b, a current is applied between the electrodes, as indicated by the arrow M3. In this manner, the front surface of the bottom part 5h is melted to resistance-weld the bottom part 5h to the cell 4b (the first welding step).

As shown in FIG. 8, the cell 4a and the cell 4b are disposed in a line by inserting the cell 4a into the side wall part 5i of the connection member 5D that is welded to the bottom part 5h in the first welding step. Note that the inner diameter of the side wall part 5i is set in accordance with the size of an outer circumference of the cell 4a such that an outer side surface of the cell 4a inserted into the side wall part 5i and an inner side surface of the side wall part 5i come into sliding contact with each other. As a result of this contact therebetween, the negative electrode of the cell 4a and the side wall part 5i are electrically connected to each other. In other words, in the cell 4a the bottomed case 6a itself is electrically connected to the negative electrode of the electrode group 6c, as shown in FIG. 5. Thus, by coming into contact with the bottomed case 6a, the side wall part 5i is connected to the negative electrode of the cell 4a.

Next, laser-welding is performed on an end surface of the side wall part 5i rising from an outer circumferential surface of the cell 4a (the second welding step). Specifically, this second welding step radiates a laser to the end surface of the side wall part 5i, as indicated by the arrow M4. The conditions for radiating a laser are the same as those described in the embodiment above. The reason that the laser-welding can be adopted in the second welding step is because, unlike the resistance-welding, the laser-welding can be performed without pressing the connection member, lowering the risk of causing mechanical stress even on a side surface of the cell 4a.

Each of the embodiments provided above has described the production method for resistance-welding the cell 4b and each connection member 5A, 5B, 5D to each other. However, this welding can be carried out by means of the laser-welding. In other words, the welding performed in the first welding step is not limited to the resistance-welding and can be the laser-welding.

Note that the specific embodiments that are described above mainly include the inventions having the following configurations.

The present invention provides a method for producing a battery assembly having a first cell and second cell disposed serially such that a positive electrode and a negative electrode of the respective cells face each other, and a connection member provided between the first cell and the second cell and electrically connecting the positive electrode and the negative electrode of the cells that face each other, the method including a first welding step of welding the connection member to the first cell, and a second welding step of welding the connection member to the second cell subsequent to the first welding step, wherein in at least the second welding step out of the first and second welding steps, an end surface of the connection member, which rises from an outer side surface of the second cell when the connection member is brought into contact with the outer side surface, is melted and welded to the second cell without pressing the connection member.

According to the present invention, the, end surface of the connection member can be melted and welded to the second cell without pressing the connection member. As a result, mechanical stress caused in the second cell can be reduced.

The description, “without pressing,” not only means not applying force in a direction of the second cell to the connection member, but also means allowing a certain level of force to be applied to the connection member to keep the second cell and the connection member attached to each other.

In the production method described above, the connection member is preferably welded to a first end surface configuring an electrode of the first cell in the first welding step, the method further include a disposing step of disposing the second cell such that a second end surface configuring an electrode of the second cell comes into contact with the connection member obtained after the first welding step, from a side opposite to the first cell, and the connection member is preferably welded to the second end surface by melting an end surface of the connection member, which rises from the second end surface, while the second end surface is in contact with the connection member in the second welding step.

According to this production method, after welding the first cell and the connection member to each other, the second cell, which is disposed such that the connection member is disposed between the first cell and the second cell, can be welded to the connection member. Therefore, the steps required for producing a battery assembly can be made simpler than those of the conventional production method. In other words, the conventional production method requires a step of disposing both end parts of a coupling plate on two, laterally arranged electric cells and then folding the coupling plate in half after welding the end parts of the coupling plate to the electric cells to dispose both of the electric cells in a vertical line. The production method according to the present invention, on the other hand, can weld the connection member to the second cell in a state in which the second cell is disposed in a vertical direction with respect to the first cell after the first cell and the connection member are welded to each other. Therefore, the step of folding the coupling plate in half in the conventional production method can be omitted.

In the production method described above, the connection member is preferably laser-welded to the second end surface in the second welding step.

According to this production method, the second welding step can radiate a laser from between the first and second end surfaces of the cells (sides of the cells) to the end surface of the connection member disposed in a limited space between the first end surface and the second end surface. Therefore, the connection member can reliably be welded to the second end surface.

In the production method described above, it is preferred that the production method further have a separation step of separating the first end surface and the second end surface by a predetermined distance, the first end surface and the second end surface being disposed in the disposing step, such that, in the second welding step, a laser can be radiated to an end surface of the connection member positioned in a region between the first cell and the second cell.

According to this method, a laser can effectively be radiated to the end surface of the connection member disposed in the limited space between the first cell and the second cell.

Specifically, the separation step can be performed by preparing the connection member in which a first contact surface in contact with the first cell and a second contact surface in contact with the second cell are separated from each other by the predetermined distance.

Laser-welding, for example, is considered to be performed in the first welding step; however, the first welding step is not limited to laser-welding. Specifically, in the production method, the connection member can be resistance-welded to the first end surface in the first welding step.

According to this production method, in a step prior to the step of connecting the second cell, which is a step prior to a step of restricting a space on the first end surface by means of the second cell, this space can be used to let the electrodes fall to the connection member disposed on the first end surface, to effectively perform the resistance-welding.

According to the production method, although the connection member is resistance-welded to the first end surface of the first cell, mechanical stress that is caused in the first cell by the resistance-welding is small. The reason is as follows. The distance between an end surface configuring an electrode of a cell and a content (e.g., an electrode group) is normally set to be greater than the distance between a side surface of the cell and the content, in order to insulate the end surface and the content from each other or to secure a space for disposing a safety device. Therefore, small pressing force that is applied to each end surface has a relatively small effect on the content of the cell. In other words, the distance between the side surface of the cell and the content is set to be as small as possible in order to respond to a recent request for a reduction in size of a cell. Therefore, an effect by the pressing force applied to the side surface of the cell is greater than that by the pressing force applied to the end surface of the cell.

The present invention also provides a battery assembly produced using the production method described above.

The present invention provides a battery assembly having first and second cells disposed in series and a connection member provided between the first cell and the second cell and electrically connecting a positive electrode and a negative electrode of the respective cells that face each other, wherein a first welding part in which the first cell and the connection member are welded to each other and a second welding part in which the second cell and the connection member are welded to each other are provided in a region between the first cell and the second cell, and at least the second welding part out of the first and second welding parts is a laser-welding part with respect to an end surface of the connection member, which rises from a front surface of the second cell.

According to the battery assembly of the present invention, because the first welding part and the second welding part are provided in the region between the first cell and the second cell, the battery assembly of the present invention can be made smaller than the one obtained when the first welding part or the second welding part is formed outside the region between the cells.

The reason that such a small battery assembly can be provided is because at least the second welding part out of the first and second welding parts provided in the region between the cells is a laser-welding part. For instance, it is difficult to dispose the second cell so as to have the connection member between the first cell and the second cell and to resistance-weld the second cell and the connection member to each other in the region between the cells after the connection member is resistance-welded to the end surface of the first cell (after the first welding part is formed). This is because it is difficult to let the electrode for resistance-welding fall onto the space between the cells. For this reason, the battery assembly according to the present invention in which both of the welding parts are disposed between the cells can be obtained by radiating a laser into the region between the cells.

In the battery assembly according to the present invention, at least the second welding part is the laser-welding part, as described above. Therefore, when forming the second welding part, the connection member can be welded to the second cell without pressing the connection member. As a result, mechanical stress that is caused in the second cell can be reduced. The description, “at least the second welding part is a laser-welding part,” also means that both the first and second welding part can be the laser-welding part.

Note that the meaning of “without pressing” is the same as above.

In this battery assembly, it is preferred that the connection member have a first contact surface that comes into contact with the first cell and a second contact surface that comes into contact with the second cell, wherein the first contact surface and the second contact surface are separated from each other by a predetermined distance so that a laser can be radiated to an end surface of the connection member located in a region between the first cell and the second cell.

According to this configuration, a space that is required for performing laser-welding is naturally formed by providing the connection member between the first cell and the second cell. Consequently, changes in the design of the battery assembly, such as forming a depression on each cell to form this space, do not have to be made.

### INDUSTRIAL APPLICABILITY

The present invention can reduce mechanical stress caused in a cell.

### EXPLANATION OF REFERENCE NUMERALS

1 Battery pack
2 Battery assembly
3 Covering member
4a to 4f Cell
5A, 5B, 5D Connection member
5a First connection part
5b Second connection part
5d Base part
5e Protruding part

1. A battery assembly production method for producing a battery assembly having a first cell and a second cell disposed serially such that a positive electrode and a negative electrode of the respective cells face each other, and a connection member that has a connection part provided between the first cell and the second cell and electrically connecting the positive electrode and the negative electrode of the cells that face each other, the connection part is smaller than the size of an outer diameter of each of the cells,
the method comprising:
a first welding step of welding the connection part to the first cell;
a separation step of separating the first cell and the second cell from each other by a distance in which a laser can be radiated to an end surface of the connection part that is positioned in a region between the first cell and the second cell and rises from a second end surface configuring an electrode of the second cell, by preparing the connection member having the connection part that has a first contact surface in contact with a first end surface configuring an electrode of the first cell and a second contact surface in contact with the second end surface and separated from the first contact surface by a predetermined distance; and
a second welding step of laser welding the second contact surface to the second cell subsequent to the separation step.

2. The battery assembly production method according to claim 1, wherein
a slit for dividing the first contact surface is formed in the connection part, and
in the first welding step, the connection part is resistance-welded to the first cell by applying a current between welding electrodes in a state where a pair of the welding electrodes are brought into abutment against positions having the slit of the connection part therebetween.

3. The battery assembly production method according to claim 1, wherein in the separation step, the first cell and the second cell are separated from each other so as to be able to radiate a laser having an optical axis angle of 5° to 30° with respect to the second end surface.

4. A battery assembly, produced using the battery assembly production method described in claim 1.

5. A battery assembly, comprising:
first and second cells disposed serially such that a positive electrode and a negative electrode of the respective cells face each other; and
a connection member that has a connection part which is provided between the first cell and the second cell and electrically connects the positive electrode and the negative electrode, which face each other, of the cells, and which is smaller than the size of an outer diameter of each of the cells,
wherein the connection part has a first contact surface that comes into contact with a first end surface configuring an electrode of the first cell and a second contact surface that comes into contact with a second end surface configuring an electrode of the second cell,
wherein the first contact surface and the second contact surface are separated from each other by a predetermined distance such that the first cell and the second cell are separated from each other by a distance so that a laser can be radiated to an end surface of the connection part that is positioned in a region between the first cell and the second cell and that rises from the second end surface, and
wherein a laser welding part for laser-welding the second contact surface to the second cell is provided in the end surface of the connection part that rises from the second end surface

6. The battery assembly according to claim 5, wherein a slit for dividing the first contact surface is formed in the connection part in order to bring a pair of resistance welding electrodes into abutment against positions having the slit therebetween.

7. The battery assembly according to claim 5, wherein an interval between the first cell and the second cell is determined so as to be able to radiate a laser having an optical axis angle of 5° to 30° with respect to the second end surface

8-9. (canceled)
